(19) United States
(12) Patent Application Publication
(10) Pub. No.: US 2021/0161740 A1
(43) Pub. Date: Jun. 3, 2021

(54) SINGLE-HANDEDLY OPERABLE WHEELCHAIR

(71) Applicant: RESEARCH INSTITUTE FOR LIFE SPACE, LLC, Sapporo-shi (JP)

(72) Inventor: Toru SAITO, Sapporo-shi (JP)

(73) Assignee: RESEARCH INSTITUTE FOR LIFE SPACE, LLC

(21) Appl. No.: 16/953,332

(22) Filed: Nov. 20, 2020

(30) Foreign Application Priority Data
Nov. 29, 2019 (JP) 2019-216235

(51) Int. Cl. A61G 5/02

(52) U.S. Cl. CPC A61G 5/028

(57) ABSTRACT

Provided is a lightweight and inexpensive wheelchair that can be easily operated with either a right or left hand. The wheelchair according to the present invention is provided with; a pair of handrims having a first portion connected to each handrim spoke and a second portion connected to a base of each wheel; a drive mechanism for transmitting a first rotational force generated by the first portion on one side and/or another side to the wheel on the one side and the wheel on the other side, wherein the drive mechanism includes an axle on the one side, an axle on the other side connected to the axle on the one side via a rotary shaft, a first two-way clutch located on the axle on the one side, and a second two-way clutch located on the axle on the other side.

### CROSS-REFERENCES TO RELATED APPLICATIONS

This patent specification is based on Japanese patent application, No. 2019-216235 filed on Nov. 29, 2019, in the Japan Patent Office, the entire contents of which are incorporated by reference herein.

### BACKGROUND OF THE INVENTION

### 1. Field of the Invention

The present invention generally relates to a manual wheelchair (hereinafter, simply referred to as a “wheelchair”). More specifically, the present invention relates to a lightweight and inexpensive wheelchair that can be easily operated by either a right or left hand.

### 2. Description of Related Art

A wheelchair is configured so that a wheelchair user (hereinafter, simply referred to as a “user”) operates right and left wheels by his/her hand to move forward, backward, right turn, and left turn. However, it is difficult for a person with a disability on either the right or left side of the body to use a general wheelchair because they cannot use both hands freely. Therefore, a single-hand-operated wheelchair that can be operated with only a healthy hand, even if the right or left body is disabled, has been proposed (see Patent Document 1). The wheelchair described in Patent Document 1 is configured such that the wheelchair disposes a double handrim outside a wheel on a side, where a healthy half of the body of a user is located so that the movement of the wheelchair can be controlled by operating the handrim with the healthy hand.

On the other hand, a wheelchair has also been proposed in which a rotary shaft connecting right and left wheels and an operating device such as a lever and a clutch are interlocked, and these operating devices are operated by a single hand to control the wheelchair as desired (see Patent Documents 2 to 4). Further, the wheelchair described in Patent Document 5 was developed by the present inventor and has a feature that it can be easily operated by either a right or left hand.

Patent Document 1: Japanese Examined Utility Model Application Publication No. 46-13386

Patent Document 2: Japanese Unexamined Patent Application Publication No. 2004-141452

Patent Document 3: Japanese Unexamined Patent Application Publication No. 2010-279666

Patent Document 4: Japanese Patent No. 5105256

Patent Document 5: Japanese Patent No. 6288746

### BRIEF SUMMARY OF THE INVENTION

However, the wheelchair described in Patent Document 1 is not convenient for wheelchair users, because handrim for operation is disposed on only one side of the right and left sides, and the operable side is predetermined. For this reason, there is an issue that two types of operation, both right and left, have to be manufactured, which contributes to high cost. Further, the wheelchair described in Patent Document 2 requires the operation of a lever, and the wheelchair described in Patent Document 3 requires a user to tilt his/her body to the right or left during operation, which is a physical burden. There was an issue that the physical burden was excessive. Also, the wheelchair described in Patent Document 4 has an issue that the configuration corresponding to the constant speed movement is not shown, and the usability is not good. Therefore, there is a demand for a wheelchair that can be easily operated by a healthy hand for a person with a disability on either the right or left side of the body. Furthermore, although the wheelchair described in Patent Document 5 is fortunately well received, there has been a demand for a wheelchair that can be moved by easier operation, is lightweight, and is inexpensive.

The present invention has been developed given such a situation, and an objective of the present invention is to provide a lightweight and inexpensive wheelchair that can be easily operated by either a right or left hand.

According to claim 1 of the present application, the present invention provides a single-handedly operable wheelchair having a frame, a right wheel and a left wheel, a right caster and a left caster, a seat, and a pair of right and left circular cross-sectional handrims concentrically disposed with an axle of each wheel, the wheelchair including: each of the handrims formed as separate bodies, and having a first portion located at an inner lower portion of the circular cross-section and a second portion occupying a portion other than the first portion of the circular cross-section; the first portion connected to a handrim spoke; the second portion connected to a base of each wheel; and a drive mechanism for transmitting a first rotational force generated by the first portion of the handrim on one side and/or another side to the wheel on the one side and the wheel on the other side. A second rotational force generated by the second portion of the handrim on the one side and/or the other side is transmitted to the wheel on the corresponding side. The drive mechanism has the axle on the one side connected to the handrim spoke on the one side, the axle on the other side connected to the axle on the one side via a rotary shaft and connected to the handrim spoke on the other side, a first two-way clutch disposed on the axle on the one side, and a second two-way clutch disposed on the axle on the other side. The first two-way clutch is configured to transmit the first rotational force to the wheel on the one side and is not configured to transmit the second rotational force generated by the second portion of the handrim on the one side to the axle on the one side. Further, the second two-way clutch is configured to transmit the first rotational force to the wheel on the other side and is not configured to transmit the second rotational force generated by the second portion of the handrim on the other side to the axle on the other side.

According to claim 2 of the present application, the present invention provides a single-handedly operable wheelchair having a frame, a right wheel and a left wheel, a right caster and a left caster, a seat, and a pair of right and left circular cross-sectional handrims concentrically disposed with an axle of each wheel, the wheelchair including: each of the handrims formed as separate bodies, and having a first portion located at an inner lower portion of the circular cross-section and a second portion occupying a portion other than the first portion of the circular cross-section; the first portion connected to a handrim spoke; the second portion connected to a base of each wheel; and a drive mechanism for transmitting a first rotational force generated by the first portion of the handrim on one side and/or another side to the wheel on the one side and the wheel on the other side. A second rotational force generated by the second portion of the handrim on the one side and/or the other side is transmitted to the wheel on the corresponding side. The drive mechanism has the axle on the one side connected to the handrim spoke on the one side, the axle on the other side connected to the axle on the one side via a rotary shaft and connected to the handrim spoke on the other side, a first one-way clutch disposed on the axle on the one side, and a second one-way clutch disposed on the axle on the other side. The first one-way clutch is configured to transmit only the forward rotational force of the first rotational force to the wheel on the one side and is configured to transmit only the backward rotational force of the second rotational force generated by the second portion of the handrim on the one side to the axle on the one side. Further, the second one-way clutch is configured to transmit only the forward rotational force of the first rotational force to the wheel on the other side and is configured to transmit only the backward rotational force of the second rotational force generated by the second portion of the handrim on the other side to the axle on the other side.

According to claim 3 of the present application, regarding the wheelchair of claim 1, the present invention provides the single-handedly operable wheelchair, wherein an idling mechanism for adjusting a rotational play generated during the use of the first two-way clutch and/or the second two-way clutch is provided. The idling mechanism has a third portion disposed as a separate body from the second portion at an outer upper portion of the circular cross-section of the handrim, and a plurality of roller structures disposed at predetermined intervals in a circumferential direction of the handrim. Further, the roller structure is composed of a shaft member and a roller rotatably attached to the shaft member and is housed in the space provided inside the third portion with the lower end of the roller in contact with the second portion and the shaft member fixed to the third portion.

According to claim 4 of the present application, regarding the wheelchair of claim 2, the present invention provides the single-handedly operable wheelchair, wherein an idling mechanism for adjusting a rotational play generated during the use of the first one-way clutch and/or the second one-way clutch is provided. The idling mechanism has a third portion disposed as a separate body from the second portion at an outer upper portion of a circular cross-section of the handrim, and a plurality of roller structures disposed at predetermined intervals in a circumferential direction of the handrim. Further, the roller structure is composed of a shaft member and a roller rotatably attached to the shaft member and is housed in the space provided inside the third portion with the lower end of the roller in contact with the second portion and the shaft member fixed to the third portion.

According to claim 5 of the present application, the present invention provides a single-handedly operable wheelchair having a frame, a right wheel and a left wheel, a right caster and a left caster, a seat, and a pair of right and left circular cross-sectional handrims concentrically disposed with an axle of each wheel, the wheelchair including: the handrim on one side formed as separate bodies, and having a first portion located at an inner lower portion of the circular cross-section and a second portion occupying a portion other than the first portion of the circular cross-section; the first portion and the handrim on another side connected to a handrim spoke; the second portion connected to a base of the wheel on the one side; and a drive mechanism for transmitting a first rotational force generated by the first portion of the handrim on the one side and/or by the handrim on the other side to the wheel on the one side and the wheel on the other side. A second rotational force generated by the second portion of the handrim on the one side is transmitted to the wheel on the one side. The drive mechanism has the axle on the one side connected to the handrim spoke on the one side, the axle on the other side connected to the axle on the one side via a rotary shaft and connected to the handrim spoke on the other side, a first one-way clutch disposed on the axle on the one side, and a second one-way clutch disposed on the axle on the other side. The first one-way clutch is configured to transmit only the forward rotational force of the first rotational force to the wheel on the one side and is configured to transmit only the backward rotational force of the second rotational force generated by the second portion of the handrim on the one side to the axle on the one side. Further, the second one-way clutch is configured to transmit only the forward rotational force of the first rotational force to the wheel on the other side.

According to claim 6 of the present application, regarding the wheelchair of claim 5, the present invention provides the single-handedly operable wheelchair, wherein an idling mechanism for adjusting a rotational play generated during the use of the first one-way clutch and/or the second one-way clutch is provided. The idling mechanism has a third portion disposed as a separate body from the second portion at an outer upper portion of a circular cross-section of the handrim, and a plurality of roller structures disposed at predetermined intervals in a circumferential direction of the handrim. Further, the roller structure is composed of a shaft member and a roller rotatably attached to the shaft member and is housed in the space provided inside the third portion with the lower end of the roller in contact with the second portion and the shaft member fixed to the third portion.

According to an embodiment of the present invention, there is provided a wheelchair capable of performing minimum necessary moving control by simple operation using only one hand. In the embodiment of the present invention, a handrim is divided into a plurality of portions, and it is not necessary to change the way of grasping the handrim so that it is easy to use. Further, by equipping an idling mechanism, a rotational play of a clutch can be adjusted and the wheelchair can be accurately controlled. Also, a wheelchair of a type for rehabilitation training is provided.

The wheelchair according to the embodiment of the present invention can even be used by anyone other than a person with a disability on either the right or left side of the body. That is, the wheelchair according to the embodiment of the present invention is useful when a person who has healthy both hands moves in the wheelchair with an article (smartphone, tableware, umbrella, or the like) in a single hand. It is also useful when playing sports such as tennis or basketball in a wheelchair. Further, as will be described in detail later, the wheelchair according to the embodiment of the present invention is useful compared to a conventional both-hands-wheelchair, in that it can be used for an uphill movement while resting according to the physical strength of the user.

### BRIEF DESCRIPTION OF THE DRAWINGS

FIG. 1 is a right side view showing a wheelchair, according to an embodiment of the present invention.

FIG. 2 is a rear view of the wheelchair of FIG. 1.

FIG. 3A is a view showing a cross-section of a handrim, and FIG. 3B is a view showing a cross-section of a handrim of another form.

FIG. 4A is a view showing a state in which a first portion and a second portion of the handrim of FIG. 3A are grasped by the right hand, FIG. 4B is a view showing a state in which the second portion of the handrim of FIG. 3A is grasped by the right hand, FIG. 4C is a view showing a state in which a first portion and a second portion of the handrim of FIG. 3B are grasped by the right hand, and FIG. 4D is a view showing a state in which the second portion of the handrim of FIG. 3B is grasped by the right hand.

FIG. 5 is a cross-sectional view taken along line 5-5 of FIG. 1, showing a configuration of right and left drive mechanisms of the wheelchair.

FIG. 6 is an enlarged cross-sectional view of a portion of 6 in FIG. 5.

FIG. 7A is a view showing an example of a two-way clutch, and FIGS. 7B, 7C, 7D, 7E, and 7F are views showing an operating state of the two-way clutch.

FIG. 8A is a view showing an example of a one-way clutch, FIG. 8B is an enlarged view of a portion of the one-way clutch, and FIG. 8C is a cam of the one-way clutch. FIGS. 8D, 8E, 8F, and 8G are views showing an operating state of the one-way clutch.

FIGS. 9A, 9B, 9C, and 9D are schematic views for explaining an operating state of the wheelchair.

FIG. 10A and 10B are views showing connection routes of the first portions of the right and left handrims.

FIG. 11 is a view showing a modified form of the drive mechanism of the wheelchair, corresponding to FIG. 6.

FIGS. 12A, 12B, and 12C are views for explaining an idling mechanism, FIG. 12A is a view showing a right handrim provided a third portion, and FIG. 12B is a view taken along line 12b-12b of FIG. 12A. FIG. 12C is an enlarged view of a portion of 12c in FIG. 12B.

FIGS. 13A,13B,13C, and 13D are views showing a state in which the handrim provided with the third portion is grasped by the right hand, corresponding to FIGS. 4A and 4B.

FIGS. 14A,14B,14C, and 14D are views showing a state in which the handrim provided with a recess instead of a convex portion is grasped by the right hand, corresponding to FIGS. 13A to 13D.

FIG. 15A, 15B, and 15C are views showing a modified form of the handrim.

### DETAILED DESCRIPTION OF THE INVENTION

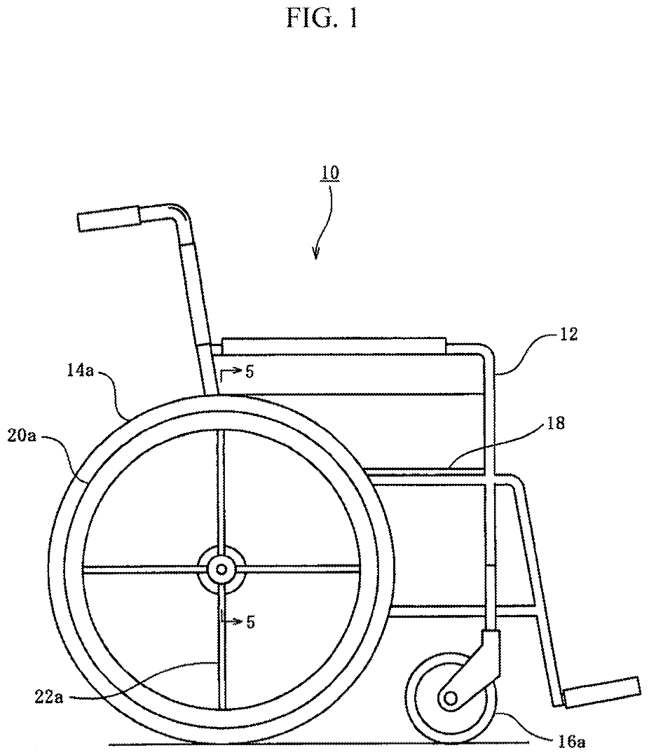

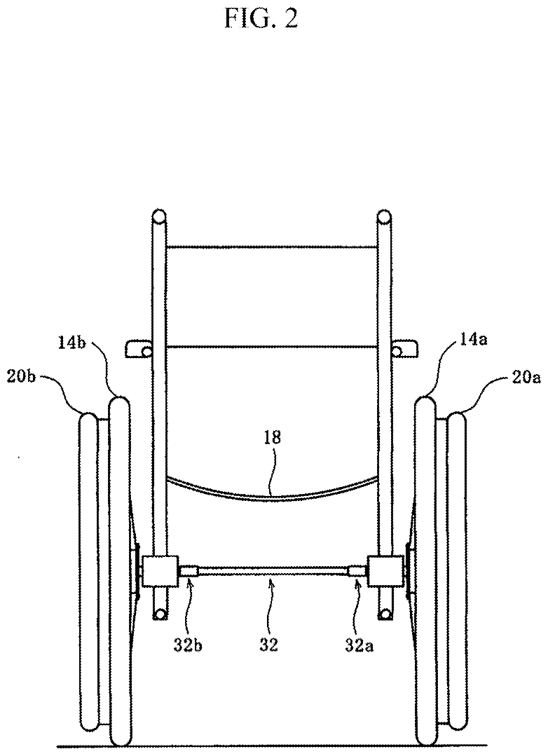

Next, a wheelchair, according to an embodiment of the present invention, will be described in detail with reference to the drawings. FIG. 1 is a right side view showing the wheelchair, according to the embodiment of the present invention. FIG. 2 is a rear view of the wheelchair shown in FIG. 1.

According to the embodiment of the present invention, as shown by a reference numeral 10 as a whole in FIG. 1, the wheelchair has a frame 12 forming a skeleton of the wheelchair, a right wheel 14a and a left wheel 14b, a pair of casters 16a and 16b, and a seat 18. The wheelchair 10 is symmetrical concerning its centerline, and has the same component on each of the right and left sides. In the following description, “a” is attached to the reference symbol of the component located on the right side of the wheelchair 10, and “b” is attached to the reference symbol of the component located on the left side of the wheelchair 10. Hereinafter, the configuration of the right side portion of the wheelchair 10 will be mainly described.

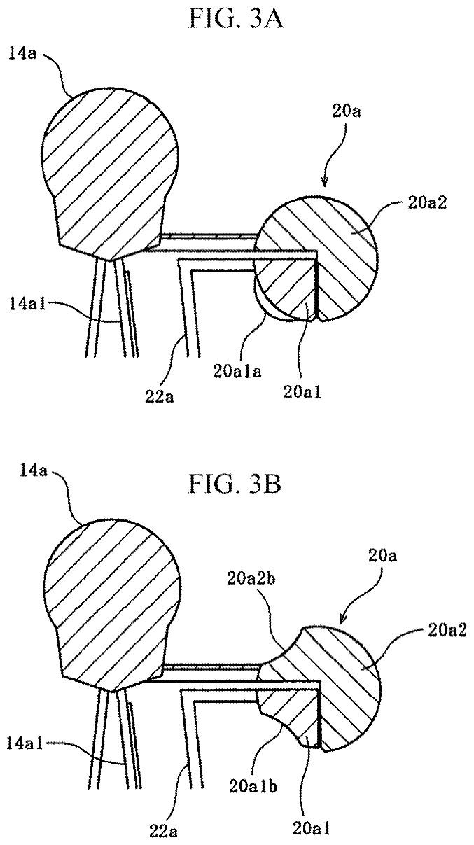

The wheelchair 10 also has a handrim 20a disposed concentrically of an axle 24a of the right wheel 14a. As shown in FIG. 3A, the handrim 20a has two portions, that is, a first portion 20a1 located at an inner lower portion of the circular cross-section, and a second portion 20a2 occupying a portion other than the first portion 20a1 of the circular cross-section. The first portion 20a1 and the second portion 20a2 are formed as separate bodies. As a result, when a user grasps the handrim 20a, fingertips of fingers other than a thumb come into contact with the first portion 20a1, and the thumb and palm come into contact with the second portion 20a2. The portion intended by the user (only the first portion 20a1, only the second portion 20a2, or both the first portion 20a1 and the second portion 20a2) can be operated. In the specification, “inward” means a side where the user sitting in the wheelchair is located, and “outward” means the opposite side to the side where the user is located.

As shown in FIG. 3A, a convex portion 20a1a is provided on the outer surface of the first portion 20a1 of the handrim 20a to improve the grip of the fingers. By providing the convex portion 20a1a, an effect that the user can easily recognize the first portion 20a1 with the finger can be expected. Instead of providing the convex portion 20a1a, as shown in FIG. 3B, a recess 20a1b may be provided on the outer surface of the first portion 20a1 of the handrim 20a. A recess 20a2b may also be provided on the outer surface of the second portion 20a2 of the handrim 20a. Similar to the convex portion 20a1a, the recess 20a1b and the recess 20a2b can be expected to have the effects of improving the grip strength of the fingers and making it easier for the user to recognize the first portion 20a1 and the second portion 20a2 with the fingers.

The first portion 20a1 of the handrim 20a is connected to a handrim spoke 22a, and the second portion 20a2 is connected to a base of the right wheel 14a.

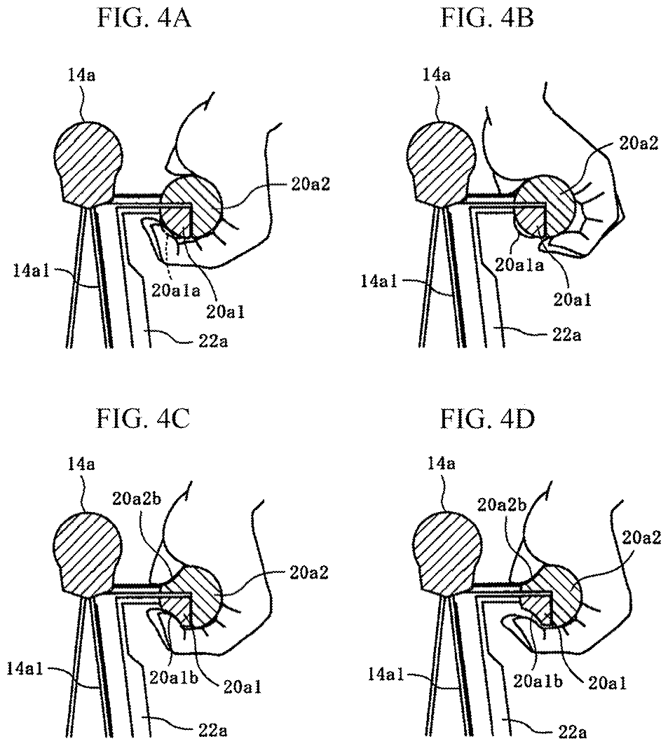

FIG. 4A shows a state in which the first portion 20a1 and the second portion 20a2 of the handrim 20a shown in FIG. 3A are grasped by the right hand, and FIG. 4B shows a state in which only the second portion 20a2 is grasped by the right hand. Moreover, FIG. 4C shows a state in which the first portion 20a1 and the second portion 20a2 of the handrim 20a shown in FIG. 3B are grasped by the right hand, and FIG. 4D shows a state in which only the second portion 20a2 is grasped by the right hand.

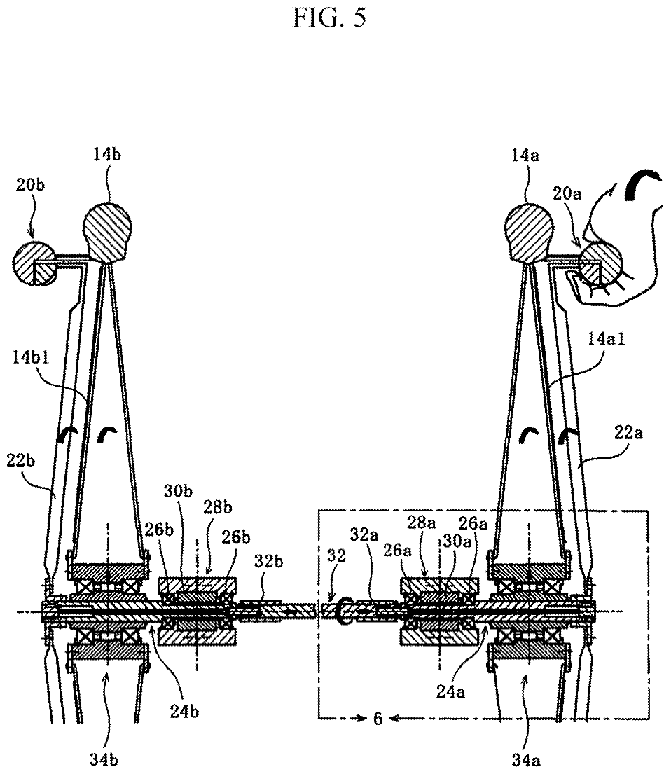

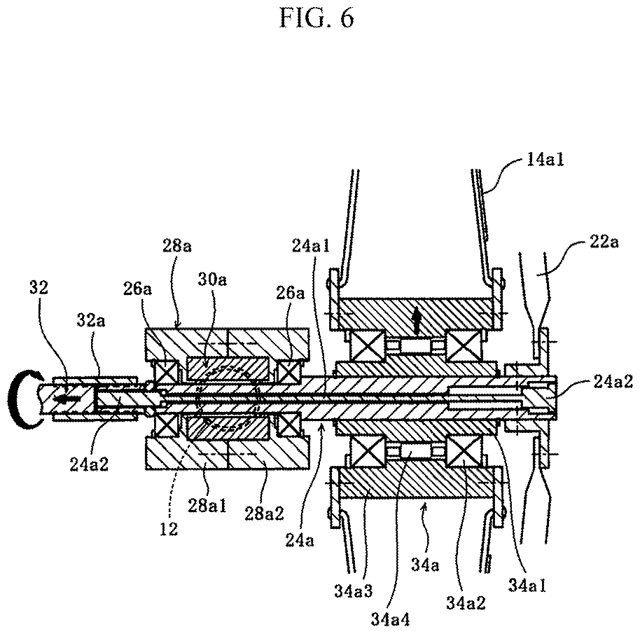

Next, the configuration of right and left drive mechanisms of the wheelchair 10 will be described with reference to FIGS. 5 and 6. FIG. 5 is a cross-sectional view taken along line 5-5 of FIG. 1, and FIG. 6 is an enlarged cross-sectional view of a portion of 6 in FIG. 5. The wheelchair 10 includes the axle 24a that supports the right wheel 14a, and the axle 24a is mounted to the frame 12 via an axle holder 28a and a mounting boss 30a. The handrim spoke 22a is connected to the outer end of the axles 24a.

The axle 24a is rotatably supported in the axle holder 28a (and therefore the frame 12) by bearings 26a. Also, the left side portion of the wheelchair 10 is provided with an axle 24b having the same configuration at the corresponding location. The axle 24a and the axle 24b form one rotating shaft via a columnar rotary shaft 32 and connection sleeves 32a, 32b.

The axle holder 28a is configured to sandwich the mounting boss 30a of a conventional wheelchair by a pair of holder members 28a1 and 28a2 (see FIG. 6) each having the bearing 26a as a retrofit attachment to the conventional wheelchair. It is possible to replace wheels 14a and 14b with wheels of the present invention while keeping the conventional wheelchair frame as it is.

In FIG. 5, for convenience of drawing, the rotary shaft 32 is shown as being right and left separated, but in actuality, the rotary shaft 32 is formed of one cylindrical shaft. Further, the axle 24a, the rotary shaft 32, and the axle 24b may be integrally formed.

In FIGS. 5 and 6, the axles 24a and 24b are hollow, and a rod 24a1 provided with a raised portion 24a2 at both ends is inserted. The rod 24a1 is for releasably mounting the right wheel 14a to the frame 12. Such the configuration itself of the axle 24a is known and is not configured in the subject matter of the present invention.

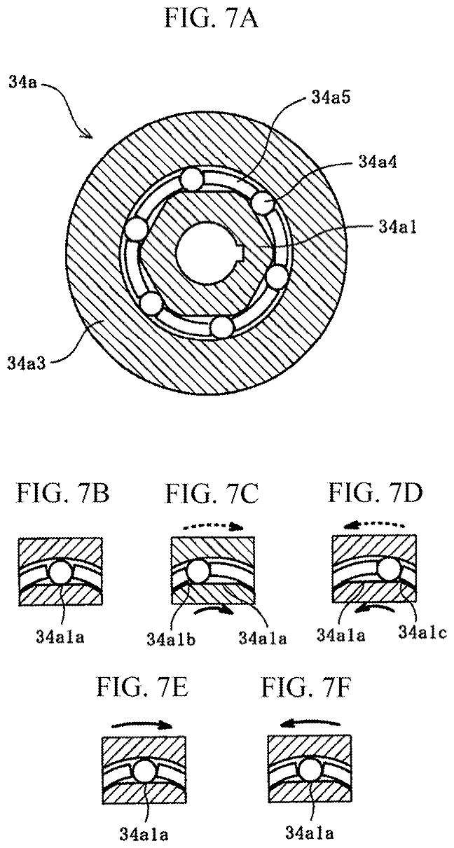

A two-way clutch 34a is attached to the axle 24a outside the axle holder 28a. Here, the two-way clutch 34a refers to a clutch that can transmit a rotational force in the same direction as the input when inputting to an inner ring 34a1 described later and cannot transmit a rotational force when inputting to an outer ring 34a3. The two-way clutch 34a includes the inner ring 34a1 of a regular polygon (a regular hexagon in the example shown in FIG. 7A) non-rotatably attached to the axle 24a outside the axle holder 28a, and the cylindrical outer ring 34a3 rotatably supported on the inner ring 34a1 by a bearing 34a2 in a state in which the outer ring 34a3 is spaced apart from the inner ring 34a1. The inner ring 34a1 is attached to the axle 24a by using a keyway (see FIG. 7A), press-fitting, or the like so as not to rotate. A rotation of the axle 24a in both directions (clockwise and counterclockwise) causes a rotation of the inner ring 34a1 in the same directions. Each side of the regular polygonal inner ring 34a1 is a cam surface, and one roller is provided in a gap between each side of the regular polygonal inner ring 34a1 and the outer ring 34a3, as shown in FIG. 7A. A cage 34a5 is arranged between the rollers 34a4, and the distance between the rollers 34a4 is maintained. The inner ring 34a1 serving as an input shaft or an output shaft is connected to the axle 24a attached to the handrim spoke 22a, and the outer ring 34a3 serving as an output shaft or an input shaft is connected to a wheel spoke 14a1 of the right wheel 14a.

The operation of the two-way clutch 34a configured as described above will be described with reference to FIGS. 7B to 7F. A solid arrow indicates an input rotation, and a dashed arrow indicates an output rotation. The clockwise rotation of the inner ring 34a1 causes the movement of the roller from the middle portion of each side 34a1a of the inner ring 34a1 (see FIG. 7B) to a left end portion 34a1b of each side 34a1a (see FIG. 7C). (During that time, the rotation of the inner ring 34a1 does not cause the rotation of the outer ring 34a3.) Reaching the left end 34a1b of the roller 34a4 causes a lock on a rotation of the roller 34a4. The rotation of the inner ring 34a1 (see the solid arrow in FIG. 7C) causes a transmission to the outer ring 34a3 and causes the clockwise rotation of the outer ring 34a3 (see the dashed arrow in FIG. 7 C). The counterclockwise rotation of the inner ring 34a1 causes the movement of the roller 34a4 from the middle portion of each side 34a1a of the inner ring 34a1 (see FIG. 7B) to a right end portion 34a1c of each side 34a1a (see FIG. 7D). (During that time, the rotation of the inner ring 34a1 does not cause the rotation of the outer ring 34a3.) Reaching the right end 34a1c of the roller 34a4 causes a lock on the rotation of the roller 34a4. The rotation of the inner ring 34a1 (see the solid arrow in FIG. 7D) causes the transmission to the outer ring 34a3 and causes the counterclockwise rotation of the outer ring 34a3 (see the dashed arrow in FIG. 7D). On the other hand, the clockwise rotation of the outer ring 34a3 (see the solid arrow in FIG. 7E) does not cause the transmission of the rotational force of the outer ring 34a3 to the inner ring 34a1 and does not cause the rotation of the inner ring 34a1, because the inner surface of the outer ring 34a3 is not a cam surface but a circular surface. Further, the counterclockwise rotation of the outer ring 34a3 (see the solid arrow in FIG. 7F) does not cause the transmission of the rotational force of the outer ring 34a3 to the inner ring 34a1 and does not cause the rotation of the inner ring 34a1, because the inner surface of the outer ring 34a3 is not a cam surface but a circular surface.

The configuration of the two-way clutch 34a as described above is known (for example, a two-way clutch manufactured by NTN Corporation). Further, if an input of an inner ring can cause a transmission of a rotational force of an outer ring in the same direction as the input, and the input of the outer ring cannot cause the transmission of the rotational force of the inner ring, a two-way clutch of another configuration may be adopted.

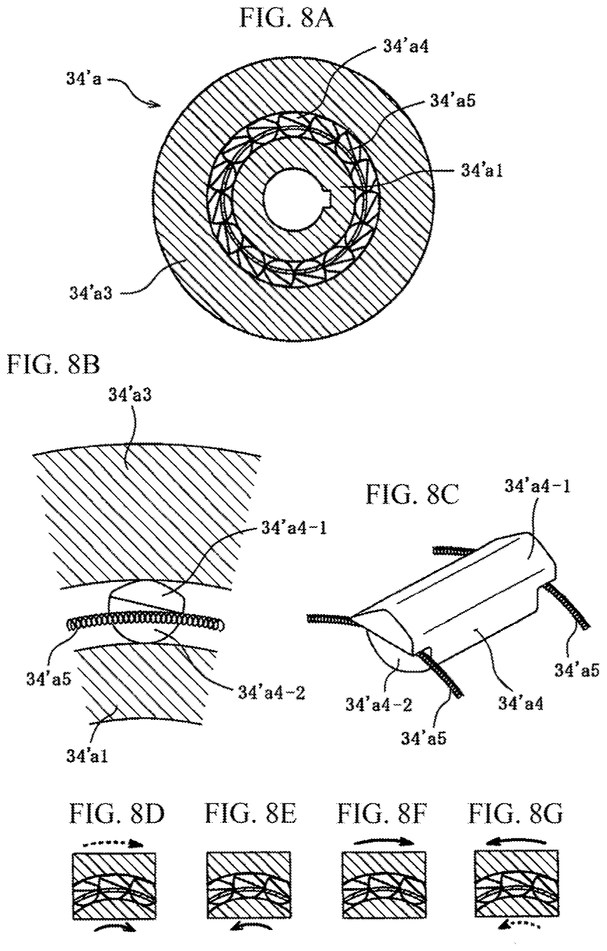

Instead of the two-way clutch 34a, a one-way clutch 34′a may be attached to the axle 24a outside the axle holder 28a. Here, the one-way clutch 34′a refers to a clutch that can transmit a rotational force only in one direction when inputting to an inner ring 34′a1 described later and can transmit a rotational force only in a direction opposite to the one direction when inputting to an outer ring 34′a3. As shown in FIG. 8A, the one-way clutch 34′a includes the cylindrical inner ring 34′a1 non-rotatably attached to the axle 24a outside the axle holder 28a, the cylindrical outer ring 34′a3 rotatably supported on the inner ring 34′a1 by a bearing 34′a2 in a state in which the outer ring 34′a3 is spaced apart from the inner ring 34′a1, and a large number of cams 34′a4 arranged between the inner ring 34′a1 and the outer ring 34′a3a. The inner ring 34′a1 is attached to the axle 24a by using a keyway (see FIG. 8A), press-fitting, or the like so as not to rotate. A rotation of the axle 24a in both directions (clockwise and counterclockwise) causes a rotation of the inner ring 34a′1 in the same directions. FIG. 8B is an enlarged view of a portion of FIG. 8A, and FIG. 8C is a perspective view showing the cam 34′a4 taken out. As shown in FIGS. 8B and 8C for the cam 34′a4, a cross-section of an upper half portion 34′a4-1 is formed into a curved convex shape, and a cross-section of a lower half portion 34′a4-2 is formed in a semicircular shape. The cam 34′a4 is always in contact with the outer circumference of the inner ring 34′a1 and the inner circumference of the outer ring 34′a3 by springs 34′a5 arranged at both ends of the cam 34′a4. The inner ring 34′a1 serving as an input shaft or an output shaft is connected to the axle 24a attached to the handrim spoke 22a, and the outer ring 34′a3 serving as an output shaft or an input shaft is connected to the wheel spoke 14a1 of the right wheel 14a.

The operation of the one-way clutch 34′a configured as described above will be described with reference to FIGS. 8D to 8G. In FIGS. 8D to 8G, a solid arrow indicates an input rotation, and a dashed arrow indicates an output rotation. A clockwise rotation of the inner ring 34′a1 (see the solid arrow in FIG. 8D) causes engagement with the cam 34′a4, the inner ring 34′a1, and the outer ring 34′a3. As a result, the clockwise rotation of the inner ring 34′a1 causes the transmission to the outer ring 34′a3, and causes a clockwise rotation of the outer ring 34′a3 (see the dashed arrow in FIG. 8D). The counterclockwise rotation of the inner ring 34′a1 (see the solid arrow in FIG. 8E) causes disengagement with the cam 34′a4, the inner ring 34′a1, and the outer ring 34′a3. As a result, the counterclockwise rotation of the inner ring 34′a1 does not cause the transmission to the outer ring 34′a3, and does not cause the rotation of the outer ring 34′a3. On the other hand, the clockwise rotation of the outer ring 34′a3 (solid arrow in FIG. 8F) causes disengagement with the cam 34′a4, the inner ring 34′a1, and the outer ring 34′a3. As a result, the clockwise rotation of the outer ring 34′a3 does not cause the transmission to the inner ring 34′a1, and does not cause the rotation of the inner ring 34′a1. The counterclockwise rotation of the outer ring 34′a3 (see the solid arrow in FIG. 8G) causes engagement with the cam 34′a4, the inner ring 34′a1, and the outer ring 34′a3. As a result, the counterclockwise rotation of the outer ring 34′a3 causes the transmission to the inner ring 34′a1, and causes the counterclockwise rotation of the inner ring 34′a1 (see the dashed arrow in FIG. 8G).

In the case of the one-way clutch 34′a, only one-way operation (usually forward operation) can be supported as compared to the two-way clutch 34a capable of both forward and backward operation, but the one-way clutch itself is cheaper than the two-way clutch and has the advantage of less rotational play. If the wheelchair 10 provided with the one-way clutches 34′a and 34′b is equipped with the idling mechanisms 36a and 36b described later, the effect of reducing the burden on the user's arm can be expected. Further, as will be described in detail later, by changing the two portions of the handrims 20a and 20b by the right and left hands, it is possible to comfortably perform an uphill movement.

The configuration of the one-way clutch 34′a as described above is known (for example, the cam clutch MZ-G series of Tsubakimoto Chain Co., Ltd.). Further, if an input of an inner ring can cause a transmission of a rotational force in only one direction, and an input of an outer ring can cause a transmission of a rotational force only in a direction opposite to one direction, a one-way clutch of another configuration may be adopted.

In the above description, the configuration of the right side portion of the wheelchair 10 has been mainly described, but the left side portion of the wheelchair 10 also has substantially the same configuration as the right side portion. That is, when describing the main components, 20b represents a handrim, 22b represents a handrim spoke, 24b represents an axle, 34b represents a two-way clutch, and 34′b represents a one-way clutch.

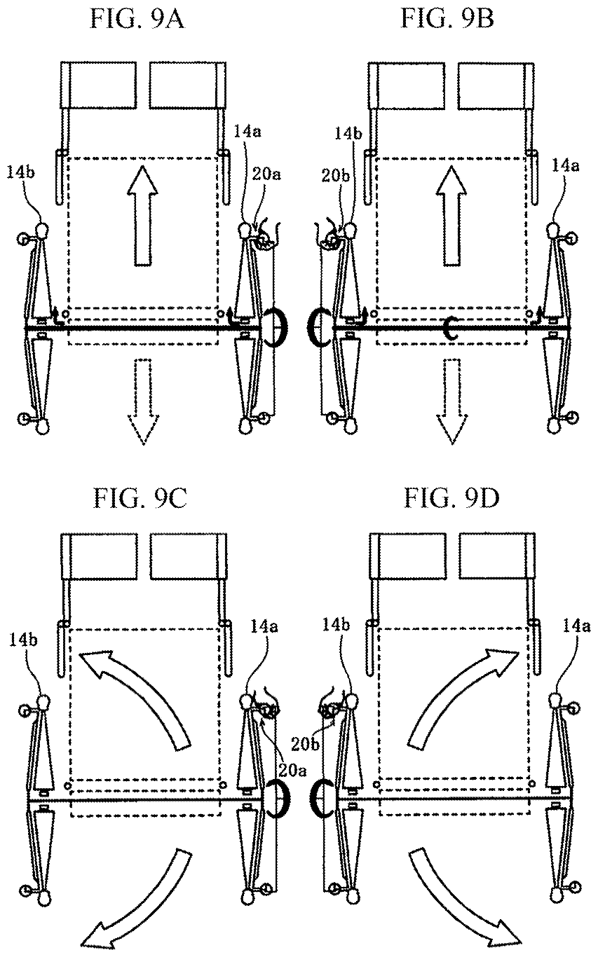

The operation of the wheelchair 10 provided with the two-way clutch 34a will be described with reference to FIGS. 9A to 9D. FIGS. 9A to 9D are schematic plan views showing a straight movement, a right-turn movement, or a left turn movement of the wheelchair 10.

When attempting to move forward by the right hand, both the first portion 20a1 and the second portion 20a2 of the handrim 20a are grasped by the right hand and rotated forward (see FIG. 9A). Then, a rotational force of the first portion 20a1 causes the transmission to the axle 24a, the two-way clutch 34a, the rotary shaft 32, the axle 24b, and the two-way clutch 34b via the handrim spoke 22a. After a rotational play of the two-way clutch 34a is eliminated, the rotational force of the first portion 20a1 causes the transmission to the outer ring 34a3 and causes the forward rotation of the right wheel 14a. Further, after a rotational play of the two-way clutch 34b is eliminated, the transmission of the rotational force of the first portion 20a1 to the outer ring 34b3 causes the forward rotation of the left wheel 14b. At the same time, the rotational force of the second portion 20a2 directly causes the transmission to the wheel (right wheel 14a) on the corresponding side and causes the forward rotation of the right wheel 14a. (At that time, the rotation of the outer ring 34a3 of the two-way clutch 34a does not cause the rotation of the inner ring 34a1.) The forward rotations of the right wheel 14a and the left wheel 14b cause the forward movement of the wheelchair 10. When attempting to move backward by the right hand, both the first portion 20a1 and the second portion 20a2 of the handrim 20a are grasped by the right hand and rotated backward. Then, the rotational force of the first portion 20a1 causes the transmission to the axle 24a, the two-way clutch 34a, the rotary shaft 32, the axle 24b, and the two-way clutch 34b via the handrim spoke 22a. After the rotational play of the two-way clutch 34a is eliminated, the rotational force of the first portion 20a1 causes the transmission to the outer ring 34a3 and causes the backward rotation of the right wheel 14a. Further, after the rotational play of the two-way clutch 34b is eliminated, the transmission of the rotational force of the first portion 20a1 to the outer ring 34b3 causes the backward rotation of the left wheel 14b. At the same time, the rotational force of the second portion 20a2 directly causes the transmission to the wheel (right wheel 14a) on the corresponding side and causes the backward rotation of the right wheel 14a. (At that time, the rotation of the outer ring 34a3 of the two-way clutch 34a does not cause the rotation of the inner ring 34a1.) The backward rotations of the right wheel 14a and the left wheel 14b cause the backward movement of the wheelchair 10 (see the dashed down arrow in FIG. 9A). Also, it is possible to move forward by both hands. In this case, both the first portion 20a1 and the second portion 20a2 of the handrim 20a are grasped by the right hand and rotated forward, and both the first portion 20b1 and the second portion 20b2 of the handrim 20b are grasped by the left hand and rotated forward.

When attempting to move forward by the left hand, both the first portion 20b1 and the second portion 20b2 of the handrim 20b are grasped by the left hand and rotated forward (see FIG. 9B). Then, a rotational force of the first portion 20b1 causes the transmission to the axle 24b, the two-way clutch 34b, the rotary shaft 32, the axle 24a, and the two-way clutch 34a via the handrim spoke 22b. After the rotational play of the two-way clutch 34b is eliminated, the rotational force of the first portion 20b1 causes the transmission to the outer ring 34b3 and causes the forward rotation of the left wheel 14b. Further, after the rotational play of the two-way clutch 34a is eliminated, the transmission of the rotational force of the first portion 20b1 to the outer ring 34a3 causes the forward rotation of the right wheel 14a. At the same time, the rotational force of the second portion 20b2 directly causes the transmission to the wheel (left wheel 14b) on the corresponding side and causes the forward rotation of the left wheel 14b. (At that time, the rotation of the outer ring 34b3 of the two-way clutch 34b does not cause the rotation of the inner ring 34b1.) The wheelchair 10 moves forward. When attempting to move backward by the left hand, both the first portion 20b1 and the second portion 20b2 of the handrim 20b are grasped by the left hand and rotated backward. Then, the rotational force of the first portion 20b1 causes the transmission to the axle 24b, the two-way clutch 34b, the rotary shaft 32, the axle 24a, and the two-way clutch 34a via the handrim spoke 22b. After the rotational play of the two-way clutch 34b is eliminated, the rotational force of the first portion 20b1 causes the transmission to the outer ring 34b3 and causes the backward rotation of the left wheel 14b. Further, after the rotational play of the two-way clutch 34a is eliminated, the transmission of the rotational force of the first portion 20b1 to the outer ring 34a3 causes the backward rotation of the right wheel 14a. At the same time, the rotational force of the second portion 20b2 directly causes the transmission to the wheel (left wheel 14b) on the corresponding side and causes the backward rotation of the left wheel 14b. (At that time, the rotation of the outer ring 34b3 of the two-way clutch 34b does not cause the rotation of the inner ring 34b1.) The wheelchair 10 moves backward (See the dashed down arrow in FIG. 9B).

When attempting to turn left by the right hand, only the second portion 20a2 of the handrim 20a is grasped by the right hand and rotated forward (see FIG. 9C). Then, the rotational force of the second portion 20a2 directly causes the transmission of the wheel (right wheel 14a) on the corresponding side and causes the forward rotation of the right wheel 14a. (At that time, the rotation of the outer ring 34a3 of the two-way clutch 34a does not cause the rotation of the inner ring 34a1.) The rotation of the right wheel 14a with the left wheel 14b not rotating causes the left turn movement of the wheelchair 10. When attempting to turn right by the right hand, first, only the second portion 20a2 of the handrim 20a is grasped by the right hand and rotated backward (see FIG. 9C). Then, the rotational force of the second portion 20a2 directly causes the transmission of the wheel (right wheel 14a) on the corresponding side. (At that time, the rotation of the outer ring 34a3 of the two-way clutch 34a does not cause the rotation of the inner ring 34a1.) The backward rotation of the right wheel 14a causes the backward movement and a right turn movement of the wheelchair 10. Then, when both the first portion 20a1 and the second portion 20a2 of the handrim 20a are grasped and rotated forward by the right hand, the wheelchair 10 consequently turns right.

When attempting to turn right by the left hand, only the second portion 20b2 of the handrim 20b is grasped by the left hand and rotated forward (see FIG. 9D). Then, the rotational force of the second portion 20b2 directly causes the transmission of the wheel (left wheel 14b) on the corresponding side and causes the forward rotation of the left wheel 14b. (At that time, the rotation of the outer ring 34b3 of the two-way clutch 34b does not cause the rotation of the inner ring 34b1.) The rotation of the left wheel 14b with the right wheel 14a not rotating causes the right turn movement of the wheelchair 10. When attempting to turn left by the left hand, first, only the second portion 20b2 of the handrim 20b is grasped by the left hand and rotated backward (see FIG. 9D). Then, the rotational force of the second portion 20b2 directly causes the transmission of the wheel (left wheel 14b) on the corresponding side. (At that time, the rotation of the outer ring 34b3 of the two-way clutch 34b does not cause the rotation of the inner ring 34b1.) The backward rotation of the left wheel 14b causes the backward movement and the left turn movement of the wheelchair 10. Then, when both the first portion 20b1 and the second portion 20b2 of the handrim 20b are grasped and rotated forward by the left hand, the wheelchair 10 consequently turns left.

By changing the two portions of the handrims 20a and 20b by the right and left hands, it is possible to comfortably perform an uphill movement. That is, for example, first, the two portions of the handrims 20a and 20b are grasped by both hands and rotated forward to perform the uphill movement. When rowing once and then stopping, it is enough to grasp both the first portion 20a1 and the second portion 20a2 of the handrim 20a by the right hand without rotating. Next, the left hand is separated from the first portion 20b1 and the second portion 20b2 of the handrim 20b and returned to the first rowing position, and both the first portion 20b1 and the second portion 20b2 of the handrim 20b are grasped without the rotation by the left hand to keep the stop. Next, the right hand is separated from the first portion 20a1 and the second portion 20a2 of the handrim 20a and returned to the first rowing position, and both the first portion 20a1 and the second portion 20a2 of the handrim 20a are grasped without the rotation by the right hand to keep the stop. While grasping the two portions of the handrims 20a and 20b by both hands, the handrims are rotated forward to perform the uphill movement. This series of operations is repeated to perform the uphill movement. In this way, by changing the right and left hands and operating, unlike the conventional both-hands-operated wheelchair, it is possible to perform the uphill movement while resting according to the physical strength of the user.

The above is the operation of the wheelchair 10 provided with the two-way clutch 34a, but the operation of the wheelchair provided with the one-way clutch 34′a (a type in which the forward rotation of the inner ring causes the forward rotation of the outer ring) instead of the two-way clutch 34a is as follows.

When attempting to move forward by the right hand, both the first portion 20a1 and the second portion 20a2 of the handrim 20a are grasped by the right hand and rotated forward (see FIG. 9A). Then, a rotational force of the first portion 20a1 causes the transmission to the axle 24a, the one-way clutch 34′a, the rotary shaft 32, the axle 24b, and the one-way clutch 34′b via the handrim spoke 22a, and causes the forward rotation of the right wheel 14a and the left wheel 14b. At the same time, the rotational force of the second portion 20a2 directly causes the transmission to the wheel (right wheel 14a) on the corresponding side. (At that time, the forward rotation of the outer ring 34′a3 of the one-way clutch 34′a does not cause the rotation of the inner ring 34′a1.) The forward rotation of the right wheel 14a and the left wheel 14b causes the wheelchair 10 to move forward.

When attempting to move forward by the left hand, both the first portion 20b1 and the second portion 20b2 of the handrim 20b are grasped by the left hand and rotated forward (see FIG. 9B). Then, the rotational force of the first portion 20b1 causes the transmission to the axle 24b, the one-way clutch 34′b , the rotary shaft 32, the axle 24a, and the one-way clutch 34′a via the handrim spoke 22b, and causes the forward rotation of the right wheel 14a and the left wheel 14b. At the same time, the rotational force of the second portion 20b2 directly causes the transmission to the wheel (left wheel 14b) on the corresponding side. (At that time, the forward rotation of the outer ring 34′b3 of the one-way clutch 34′b does not cause the rotation of the inner ring 34′b1.) The forward rotation of the right wheel 14a and the left wheel 14b causes the wheelchair 10 to move forward.

When attempting to turn left by the right hand, only the second portion 20a2 of the handrim 20a is grasped by the right hand and rotated forward (see FIG. 9C). Then, the rotational force of the second portion 20a2 directly causes the transmission to the wheel (right wheel 14a) on the corresponding side and causes the forward rotation of the right wheel 14a. (At that time, the forward rotation of the outer ring 34′a3 of the one-way clutch 34′a does not cause the rotation of the inner ring 34′a1.) The rotation of the right wheel 14a with the left wheel 14b not rotating causes the left turn movement of the wheelchair 10. When attempting to turn right by the right hand, first, only the second portion 20a2 of the handrim 20a is grasped by the right hand and rotated backward (see FIG. 9C). Then, the rotational force of the second portion 20a2 directly causes the transmission to the wheel (right wheel 14a) on the corresponding side. (At that time, the backward rotation of the outer ring 34′a3 of the one-way clutch 34′a causes the backward rotation of the inner ring 34′a1.) The backward rotation of the right wheel 14a causes the backward movement and the right turn movement of the wheelchair 10. Then, when both the first portion 20a1 and the second portion 20a2 of the handrim 20a are grasped and rotated forward by the right hand, the wheelchair 10 consequently turns right.

When attempting to turn right by the left hand, only the second portion 20b2 of the handrim 20b is grasped by the left hand and rotated forward (see FIG. 9D). Then, the rotational force of the second portion 20b2 directly causes the transmission to the wheel (left wheel 14b) on the corresponding side and causes the forward rotation of the left wheel 14b. (At that time, the forward rotation of the outer ring 34′b3 of the one-way clutch 34′b does not cause the rotation of the inner ring 34′b1.) The rotation of the left wheel 14b with the right wheel 14a not rotating causes the right turn movement of the wheelchair 10. When attempting to turn left by the left hand, first, only the second portion 20b2 of the handrim 20b is grasped by the left hand and rotated backward (see FIG. 9D). Then, the rotational force of the second portion 20b2 directly causes the transmission to the wheel (left wheel 14b) on the corresponding side. (At that time, the backward rotation of the outer ring 34′b3 of the one-way clutch 34′b causes the backward rotation of the inner ring 34′b1.) The backward rotation of the left wheel 14b causes the backward movement and the left turn movement of the wheelchair 10. Then, when both the first portion 20b1 and the second portion 20b2 of the handrim 20b are grasped and rotated forward by the left hand, the wheelchair 10 consequently turns left.

When both the first portion 20a1 and the second portion 20a2 of the handrim 20a are grasped by the right hand and rotated backward, the rotational force of the second portion 20a2 directly causes the transmission to the wheel (right wheel 14a) on the corresponding side and causes the backward rotation of right wheel 14a. (At that time, the backward rotation of the outer ring 34′a3 of the one-way clutch 34′a causes the backward rotation of the inner ring 34′a1. The backward rotation of the inner ring 34′b1 of the one-way clutch 34′b via the axle 24a, the rotary shaft 32, and the axle 24b does not cause the rotation of the outer ring 34′b3.) The backward rotation of the right wheel 14a with the left wheel 14b not rotating causes the backward movement and the right turn movement of the wheelchair 10. Further, when both the first portion 20b1 and the second portion 20b2 of the handrim 20b are grasped by the left hand and rotated backward, the rotational force of the second portion 20b2 directly causes the transmission to the wheel (left wheel 14b) on the corresponding side. (At that time, the backward rotation of the outer ring 34′b3 of the one-way clutch 34′b causes the backward rotation of the inner ring 34′b1. The backward rotation of the inner ring 34′a1 of the one-way clutch 34′a via the axle 24b, the rotary shaft 32, and the axle 24a does not cause the rotation of the outer ring 34′a3.) The backward rotation of the left wheel 14b with the right wheel 14a not rotating causes the backward movement and the left turn movement of the wheelchair 10.

In the wheelchair 10 equipped with the one-way clutches 34′a and 34′b, the backward rotation of the first portions 20a1 and 20b1 causes the rotation of the inner rings 34′a1 and 34′b1 but does not cause the rotation of the outer rings 34′a3 and 34′b3. Therefore, it is not reflected in the operation of the wheelchair 10.

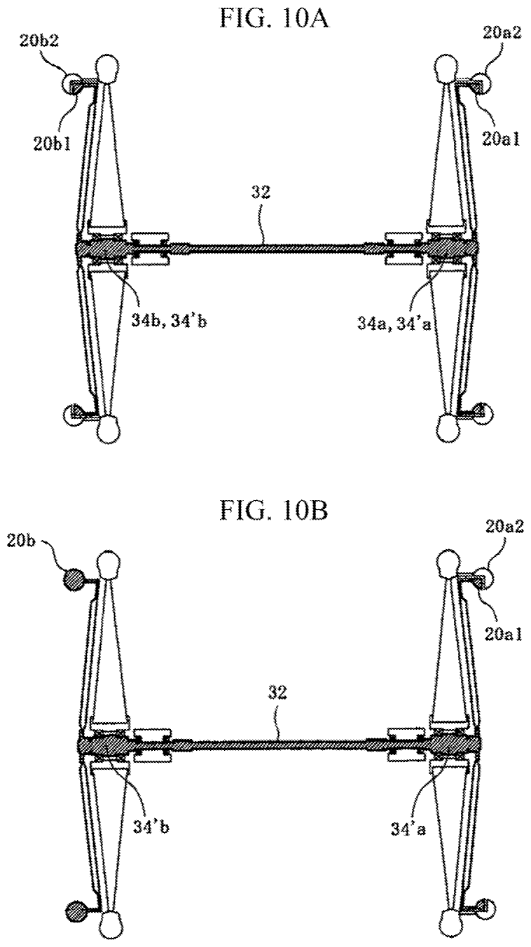

FIG. 10A is a view showing a state in which the first portion 20a1 of the handrim 20a and the first portion 20b1 of the handrim 20b are connected by the axle 24a, the rotary shaft 32, and the axle 24b. FIG. 10B is a view showing a state in which the handrim 20b on the other side, which will be described later, is not divided, and is a view a state in which the first portion 20a1 of the handrim 20a and the handrim 20b are connected by the axle 24a, the shaft member 32, and the axle 24b. In the embodiment shown in FIG. 10A, either the two-way clutch 34a, 34b, or the one-way clutch 34′a, 34′b are equipped, but in the embodiment shown in FIG. 10B, one-way clutches 34′a, 34′b are equipped.

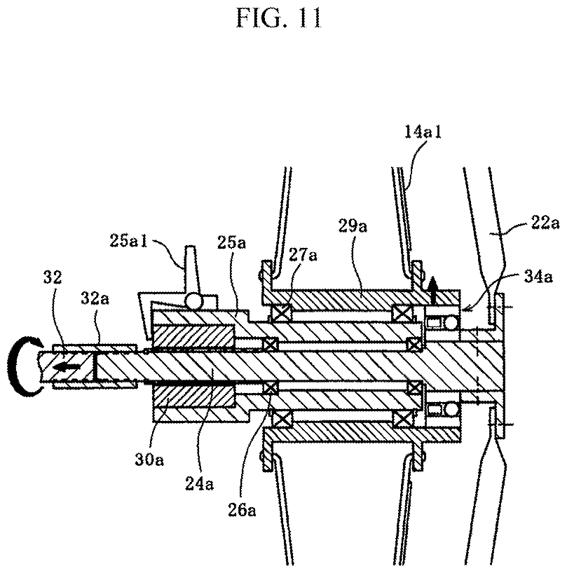

FIG. 11 is a view showing a modified form of the drive mechanism of the wheelchair 10, corresponding to FIG. 6. In the embodiment shown in FIG. 11, the axle 24a that supports the right wheel 14a is rotatably accommodated in a cylindrical axle support housing 25a by a bearing 26a, and the axle 24a is mounted to the frame 12 via the mounting boss 30a. Reference numeral 25a1 is a known lever member with an axle fixing spring used for fixing the axle 24a.

A cylindrical wheel hub 29a is rotatably supported on the shaft support housing 25a by a bearing 27a disposed on the outer surface of the shaft support housing 25a, and the wheel spoke 14a1 is connected to the wheel hub 29a. The two-way clutch 34a is disposed between the outer surface of the axle 24a and the inner surface of the wheel hub 29a. The one-way clutch 34′a may be disposed instead of the two-way clutch 34a.

The configuration including the shaft support housing 25a is different from the configuration shown in FIGS. 5 and 6, and since the axle 24a is supported by the shaft support housing 25a, it can be expected to reduce a load due to the rotation of the axle 24a.

The wheelchair 10 is equipped with idling mechanisms 36a and 36b. Here, the idling mechanisms 36a and 36b are mechanisms for adjusting the rotational play generated when the two-way clutches 34a and 34b or the one-way clutches 34′a and 34′b are used. Hereinafter, the idling mechanism 36a mounted on the right side portion of the wheelchair 10 will be described, but the idling mechanism 36b mounted on the left side portion is also the same as the idling mechanism 36a. The rotation of the first portion 20a1 of the handrim 20a causes the transmission of the rotational force to the right wheel 14a via the handrim spoke 22a and then the clutches 34a and 34′a, and causes a time lag until the right wheel 14a is rotated. The occurrence of such the time lag is caused by the slight rotational play until the rotational force is transmitted through the clutches 34a and 34′a. (Such the rotational play is particularly remarkable in the two-way clutch 34a. Even in the one-way clutch 34′a, an actual starting timing of a rotational load of the first portion 20a1 and the second portion 20a2 of the handrim 20a tends to be different at the initial stage of the movement, and it can be considered that a kind of play can occur.) If such the time lag is left, a rotation starting timing of the rotation of the right wheel 14a and the left wheel 14b will be slightly different, and as a result, the wheelchair 10 will not go straight and will make an unintended slight turn. Accurate moving control of the wheelchair 10 becomes difficult. The idling mechanism 36a is equipped to avoid such a situation. The idling mechanism 36a can also be expected to have a secondary effect of reducing the burden on the user's arm. That is, the user is usually forced to perform a motion of grasping and rotating the handrim 20a, then once releasing his/her hand from the handrim 20a, and swinging back while making an elliptical motion of his/her arm in the vertical plane, which imposes a burden on his/her arm. However, by equipping the idling mechanism 36a, it is possible to keep his/her palm resting on a third portion 20a3 of the handrim 20a, which will be described later. Therefore, it is not necessary to swing his/her arm back and the burden on his/her arm is reduced.

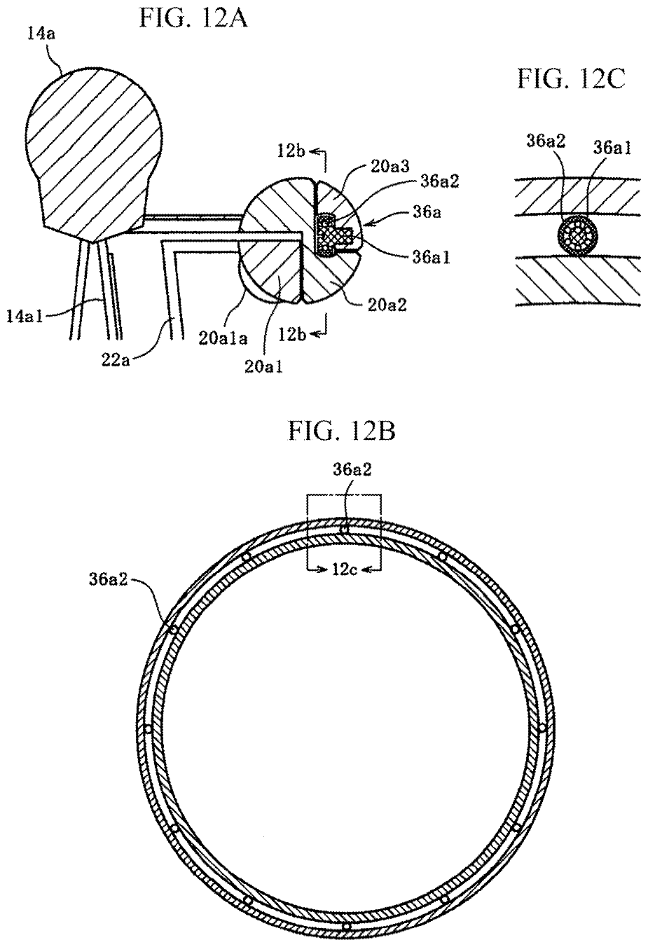

The configuration of the idling mechanism 36a will be described with reference to FIGS. 12A, 12B, and 12C. The idling mechanism 36a includes the third portion 20a3 (see FIG. 12A) disposed separately of the second portion 20a2 in the outer upper portion of the circular cross-section of the handrim 20a, the shaft member 36a1, and rollers 36a2 rotatably attached to the shaft member 36a1. The idling mechanism 36a has a plurality of roller structures disposed at predetermined intervals in the circumferential direction of the handrim 20a (see FIG. 12C). As shown in FIG. 12A, the roller structure is housed in the space provided inside the third portion 20a3, a lower end of the roller 36a2 is in contact with the second portion 20a2, and the shaft member 36a1 is fixed to the third portion 20a3.

When the idling mechanism 36a is used, the surface of the third portion 20a3 of the handrim 20a is covered with the palm, and the first portion 20a1 is slightly rotated by an amount of the rotational play while grasping the first portion 20a1 with the fingertips. Then by grasping and rotating both the first portion 20a1 and the second portion 20a2, it is possible to avoid the occurrence of the time lag.

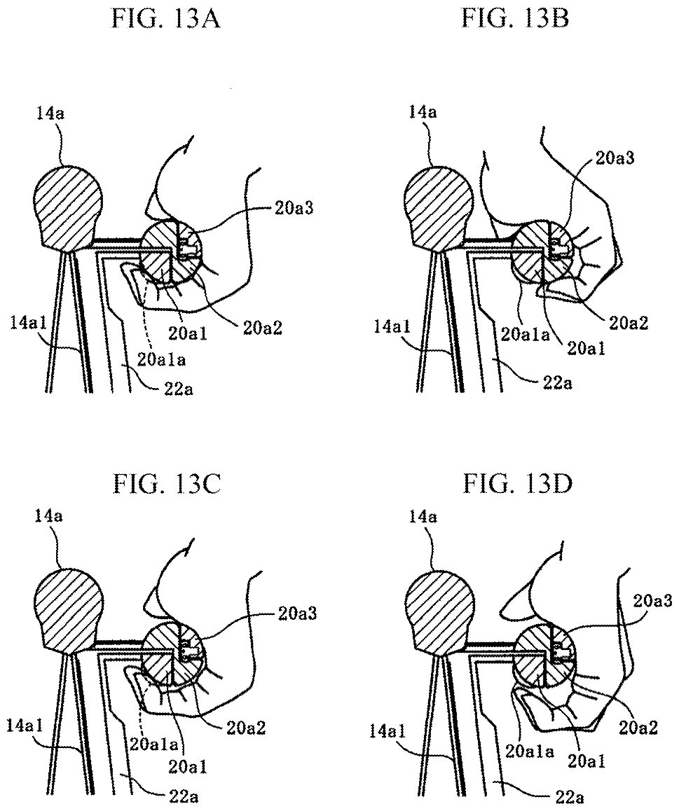

FIGS. 13A to 13D are views showing states of grasping the handrim 20a having the third portion 20a3, corresponding to FIGS. 4A and 4B. That is, FIG. 13A shows a state in which an outer surface of the third portion 20a3 is covered with the palm, the first portion 20a1 is grasped by the fingertip of the right hand, and the second portion 20a2 is grasped by the thumb of the right hand. FIG. 13B shows a state in which the outer surface of the third portion 20a3 is covered with the palm and the second portion 20a2 is grasped by the fingertip of the right hand, FIG. 13C shows a state in which the outer surface of the third portion 20a3 covered with the palm and the portion 20a1 is grasped by the fingertip of the right hand, and FIG. 13D shows a state in which only the outer surface of the third portion 20a3 is covered with the palm.

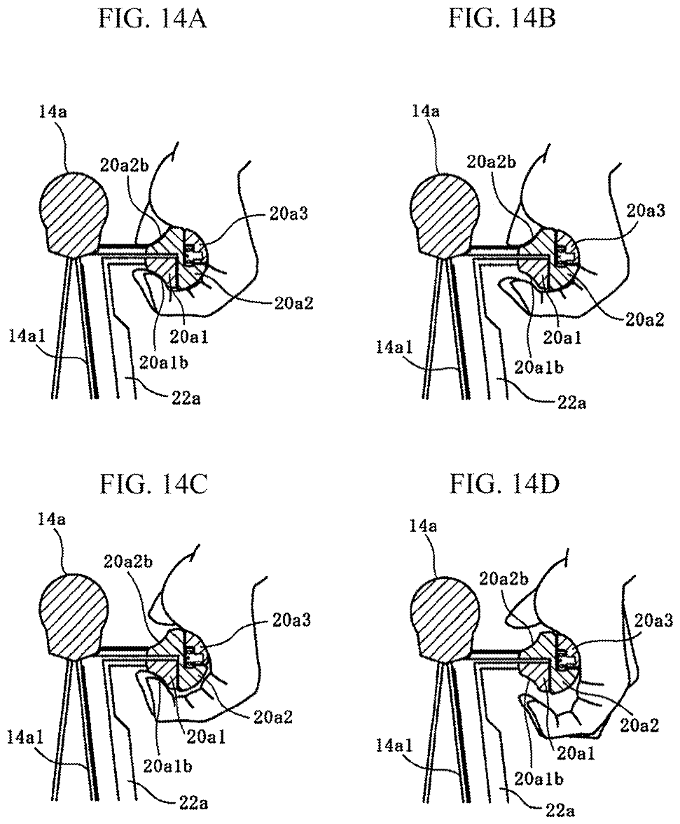

In FIGS. 13,13B,13C, and 13D, a convex portion 20a1a is provided on the first portion 20a1 of the handrim 20a, but the recess may be provided instead of the convex portion 20a1a. FIGS. 14A to 14D are respectively views corresponding to FIGS. 13A to 13D in which the recess 20a1b is provided in the first portion 20a1 and the recess 20a2b is provided in the second portion 20a2.

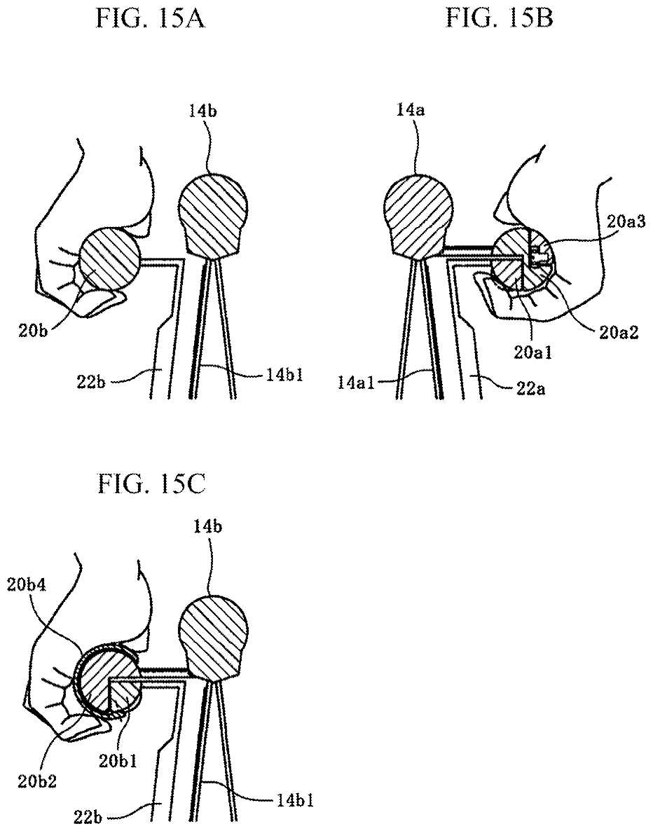

FIGS. 15A and 15C are views showing a modified form of the handrim. In FIG. 15A, the left handrim 20b is not provided with the first to the third portions. (Therefore, the left handrim 20b performs the same function as the first portion 20a1 of the right handrim 20a.) In FIG. 15B, corresponding to the left handrim, the right handrim 20a is provided with the first portion 20a1, the second portion 20a2, and the third portion 20a3. This form of the left handrim 20b is useful for users who have one hand paralyzed and the other hand not paralyzed, but for the reasons described below, one-way clutches 34′a, 34′b are provided. In the case of a user whose right hand is healthy and whose left hand is paralyzed, the left handrim 20b can be grasped by the left hand being paralyzed, and the right-hand 20a can be grasped by the healthy right hand to perform the desired operation. That is, the first portion 20a1 and the second portion 20a2 of the handrim 20a are rotated forward to perform return operation from the grasping state of FIG. 13A to the grasping state of FIG. 13C. Thereby the left handrim 20b is returned. By repeating this operation, the wheelchair 10 moves forward, and at that time, the left handrim 20b also repeats the forward rotation and the backward rotation, so that when the handrim 20b is grasped by the paralyzed left hand, the rehabilitation training of the left hand is performed. In the wheelchair 10 equipped with the two-way clutches 34a and 34b instead of the one-way clutches 34a′ and 34b′ when the first portion 20a1 of the handrim 20a is rotated backward, the wheelchair 10 moves backward and returns to the original position so that it is not suitable for such use.

In FIG. 15C, the left handrim 20b is divided into two portions, a first portion 20b1 and a second handrim 20b2, but by covering the entire outer surface of the left handrim 20b with a predetermined attachment 20b4, the handrim can be used as an undivided handrim.

In the above description, the right side portion of the wheelchair 10 has been described, but the left side portion is the same as the right side portion.

It is needless to say that the present invention is not limited to the above-described embodiments, various modifications can be made within the scope of the invention described in the claims, and these are also included in the scope of the present invention.

For example, the details of the components of the wheelchair shown are merely exemplary and these details may be modified.

### Description of the Reference Numerals

10 wheelchair
12 frame
14a, 14b wheel
14a1, 14b1 wheel spoke
16a, 16b caster
18 sheet
20a, 20b handrim
20a1, 20b1 first portion
20a2, 20b2 second portion
20a3, 20b3 third portion
20b4 attachment
22a, 22b handrim spoke
24a, 24b axle
25a, 25b shaft support housing
26a, 26b bearing
27a, 27b bearing
28a, 28b axle holder
29a, 29b wheel hub
30a, 30b mounting boss
32 rotary shaft
32a, 32b connection sleeve
34a, 34b two-way clutch
34a1, 34b1 inner ring
34a2, 34b2 bearing
34a3, 34b3 outer ring
34a4, 34b4 roller
34a5, 34b5 cage
34′a, 34′b one-way clutch
34′a1, 34′b1 inner ring
34′a2, 34′b2 bearing
34′a3, 34′b3 outer ring
34′a4, 34′b4 cam
34′a5, 34′b5 spring
36a, 36b idling mechanism
36a1, 36b1 shaft member
36a2, 36b2 roller

What is claimed is:

1. A wheelchair having a frame, a right wheel and a left wheel, a right caster and a left caster, a seat, and a pair of right and left circular cross-sectional handrims concentrically disposed with an axle of each wheel, the wheelchair comprising:
each of the handrims formed as separate bodies, and having a first portion located at an inner lower portion of the circular cross-section and a second portion occupying a portion other than the first portion of the circular cross-section;
the first portion connected to the handrim spoke;
the second portion connected to a base of each wheel; and
a drive mechanism for transmitting a first rotational force generated by the first portion of the handrim on one side and/or another side to the wheel on the one side and the wheel on the other side, wherein
a second rotational force generated by the second portion of the handrim on the one side and/or the other side is transmitted to the wheel on the corresponding side,
the drive mechanism has the axle on the one side connected to the handrim spoke on the one side, the axle on the other side connected to the axle on the one side via a rotary shaft and connected to the handrim spoke on the other side, a first two-way clutch disposed on the axle on the one side, and a second two-way clutch disposed on the axle on the other side,
the first two-way clutch is configured to transmit the first rotational force to the wheel on the one side and is not configured to transmit the second rotational force generated by the second portion of the handrim on the one side to the axle on the one side, and
the second two-way clutch is configured to transmit the first rotational force to the wheel on the other side and is not configured to transmit the second rotational force generated by the second portion of the handrim on the other side to the axle on the other side.

2. A wheelchair having a frame, a right wheel and a left wheel, a right caster and a left caster, a seat, and a pair of right and left circular cross-sectional handrims concentrically disposed with an axle of each wheel, the wheelchair comprising:
each of the handrims formed as separate bodies, and having a first portion located at an inner lower portion of the circular cross-section and a second portion occupying a portion other than the first portion of the circular cross-section;
the first portion connected to the handrim spoke;
the second portion connected to a base of each wheel; and
a drive mechanism for transmitting a first rotational force generated by the first portion of the handrim on one side and/or another side to the wheel on the one side and the wheel on the other side, wherein
a second rotational force generated by the second portion of the handrim on the one side and/or the other side is transmitted to the wheel on the corresponding side,
the drive mechanism has the axle on the one side connected to the handrim spoke on the one side, the axle on the other side connected to the axle on the one side via a rotary shaft and connected to the handrim spoke on the other side, a first one-way clutch disposed on the axle on the one side, and a second one-way clutch disposed on the axle on the other side,
the first one-way clutch is configured to transmit only the forward rotational force of the first rotational force to the wheel on the one side, and is configured to transmit only the backward rotational force of the second rotational force generated by the second portion of the handrim on the one side to the axle on the one side, and
the second one-way clutch is configured to transmit only the forward rotational force of the first rotational force to the wheel on the other side and is configured to transmit only the backward rotational force of the second rotational force generated by the second portion of the handrim on the other side to the axle on the other side.

3. The wheelchair according to claim 1, wherein
an idling mechanism for adjusting a rotational play generated during the use of the first two-way clutch and/or the second two-way clutch is provided,
the idling mechanism has a third portion disposed as a separate body from the second portion at an outer upper portion of a circular cross-section of the handrim, and a plurality of roller structures disposed at predetermined intervals in a circumferential direction of the handrim, and
the roller structure is composed of a shaft member and a roller rotatably attached to the shaft member and is housed in the space provided inside the third portion with the lower end of the roller in contact with the second portion and the shaft member fixed to the third portion.

4. The wheelchair according to claim 2, wherein
an idling mechanism for adjusting a rotational play generated during the use of the first one-way clutch and/or the second one-way clutch is provided,
the idling mechanism has a third portion disposed as a separate body from the second portion at an outer upper portion of a circular cross-section of the handrim, and a plurality of roller structures disposed at predetermined intervals in a circumferential direction of the handrim, and
the roller structure is composed of a shaft member and a roller rotatably attached to the shaft member and is housed in the space provided inside the third portion with the lower end of the roller in contact with the second portion and the shaft member fixed to the third portion.

5. A wheelchair having a frame, a right wheel and a left wheel, a right caster and a left caster, a seat, and a pair of right and left circular cross-sectional handrims concentrically disposed with an axle of each wheel, the wheelchair comprising:
the handrim on one side formed as separate bodies, and having a first portion located at an inner lower portion of the circular cross-section and a second portion occupying a portion other than the first portion of the circular cross-section;
the first portion and the handrim on another side connected to the handrim spoke;
the second portion connected to a base of the wheel on the one side; and
a drive mechanism for transmitting a first rotational force generated by the first portion of the handrim on the one side and/or by the handrim on the other side to the wheel on the one side and the wheel on the other side, wherein
a second rotational force generated by the second portion of the handrim on the one side is transmitted to the wheel on the one side,
the drive mechanism has the axle on the one side connected to the handrim spoke on the one side, the axle on the other side connected to the axle on the one side via a rotary shaft and connected to the handrim spoke on the other side, a first one-way clutch disposed on the axle on the one side, and a second one-way clutch disposed on the axle on the other side,
the first one-way clutch is configured to transmit only the forward rotational force of the first rotational force to the wheel on the one side, and is configured to transmit only the backward rotational force of the second rotational force generated by the second portion of the handrim on the one side to the axle on the one side, and
the second one-way clutch is configured to transmit only the forward rotational force of the first rotational force to the wheel on the other side.

6. The wheelchair according to claim 5, wherein
an idling mechanism for adjusting a rotational play generated during the use of the first one-way clutch and/or the second one-way clutch is provided,
the idling mechanism has a third portion disposed as a separate body from the second portion at an outer upper portion of a circular cross-section of the handrim, and a plurality of roller structures disposed at predetermined intervals in a circumferential direction of the handrim, and
the roller structure is composed of a shaft member and a roller rotatably attached to the shaft member and is housed in the space provided inside the third portion with the lower end of the roller in contact with the second portion and the shaft member fixed to the third portion.
